(19) United States
(12) Patent Application Publication
(10) Pub. No.: US 2007/0251356 A1
(43) Pub. Date: Nov. 1, 2007

(54) Spark plug wrench for confined spaces

(76) Inventor: Jerry Walter Tribby, Lewisburg, TN (US)

Correspondence Address: JAMES RICHARDS, 58 BONING RD, FAYETTEVILLE, TN, 37334, US

(21) Appl. No.: 11/411,322

(22) Filed: Apr. 26, 2006

(51) Int. Cl. B25B 13/00; B25B 23/16

(52) U.S. Cl. 81/177.8; 81/124.3

(57) ABSTRACT

A spark plug installation and removal wrench comprising a short socket with a handle pivotally attached to the socket, forming a compact assembly that can access spark plugs in tight spaces. The socket may be rotated on the pivot axis to slip over the spark plug and down to engage and drive the spark plug. Lateral force on the handle may then rotate the socket to install or remove the spark plug. In one embodiment, the handle pivot axis may run through a clearance space for the spark plug, and the handle may have a U shape to avoid interference with the spark plug. An embodiment is disclosed wherein the handle may be attached with roll pins, rivets, screws or other pivot attachment hardware.

### BACKGROUND

1. Field of the Invention

The present invention relates to the field of hand tools, more particularly to the field of hand tools with pivotally attached handles.

2. Background of the Invention

As advanced engines become more compact to reduce weight, improve efficiency, and control cost in a competitive industry, the convenience and ease of engine maintenance may take second or lower priority. The result is that routine maintenance, such as replacement of spark plugs, can require the removal of a number of other components, or even the removal of the engine to access the spark plugs. Further, when engines are modified for higher performance, better fuel mileage, or for racing or other special applications, the additional equipment or larger components, such as special headers, take up the little remaining space and present further challenges to the routine maintenance of existing components. Spark plugs maintenance, in particular, may suffer from shrinking space availability in the engine compartment.

Existing spark plug wrenches are primarily designed for straight in access or right angle turning using the end of the spark plug socket, which encloses the spark plug. The resulting assembly is too long to allow use in the tightest locations in modern engines, requiring removal of other components to access the spark plugs.

Thus, there is a need for special tools, in particular, a spark plug wrench that can be used in the confined spaces found in today's advanced engines.

### BRIEF DESCRIPTION OF THE INVENTION

Briefly, the invention relates to a spark plug installation and removal wrench comprising a short socket with a handle pivotally attached to the socket, forming a compact assembly that can access spark plugs in tight spaces. The socket may be rotated on the pivot axis to slip over the spark plug and down to engage and drive the spark plug. Lateral force on the handle may then rotate the socket to install or remove the spark plug. In one embodiment, the handle pivot axis may run through a clearance space for the spark plug, and the handle may have a U shape to avoid interference with the spark plug. An embodiment is disclosed wherein the handle may be attached with roll pins, rivets, screws or other pivot attachment hardware. In one embodiment, the pivot axis is above the bottom of the socket to allow the socket to access recessed spark plugs.

### BRIEF DESCRIPTION OF THE FIGURES

The present invention is described with reference to the accompanying drawings. In the drawings, like reference numbers indicate identical or functionally similar elements. Additionally, the left most digit(s) of a reference number identifies the drawing in which the reference number first appears.

FIG. 1A illustrates a side view of an exemplary spark plug wrench in accordance with the present invention.

FIG. 1B illustrates the wrench of FIG. 1A coupled to a spark plug.

FIG. 2A is a front view of the wrench.

FIG. 2B is an exploded view of the wrench of FIG. 2A.

FIG. 3 is a top view of the wrench.

FIG. 4 is a bottom view of the wrench.

FIG. 5 illustrates the wrench and spark plug of FIG. 1B with the handle pivoted to an angle of about 45 degrees.

FIG. 6 (prior art) illustrates a conventional spark plug wrench.

FIG. 7 (prior art) illustrates a typical engine configuration showing the potential interference that prevents the use of the conventional spark plug wrench.

FIG. 8 illustrates the engine configuration of FIG. 7 with the operation of the wrench of FIG. 1A in accordance with the present invention.

### DETAILED DESCRIPTION OF THE PREFERRED EMBODIMENTS

The present invention is directed to a wrench which may be used to install and/or remove spark plugs, especially where the spark plugs are in confined or otherwise difficult to reach locations. In accordance with the invention, the wrench comprises a socket portion and a handle portion. The socket portion is very short, typically shorter than the spark plug. The handle portion couples to the socket portion, allowing the handle to assume a range of desired angles with respect to the spark plug axis. One embodiment is disclosed wherein the handle portion is coupled to the socket using a pivot, or hinge. The handle portion may include a forked, U shaped, yoke portion to avoid interference with the spark plug. The yoke portion may couple to the socket portion at two pivot hinge points, each on opposite sides of the socket. The short socket allows the wrench to fit in locations with interference very close to the spark plug. The yoke coupling on the handle allows the handle and pivot to be placed low on the assembly, even within the length of the spark plug. Thus, the socket and handle may be not much longer and possibly even shorter than the spark plug (with the handle angled 90 degrees to the socket axis)—allowing the socket and handle to operate in very tight spaces. In one embodiment, the pivot axis is a desired distance above the bottom end of the socket to allow the socket to reach into a recess to couple to the spark plug.

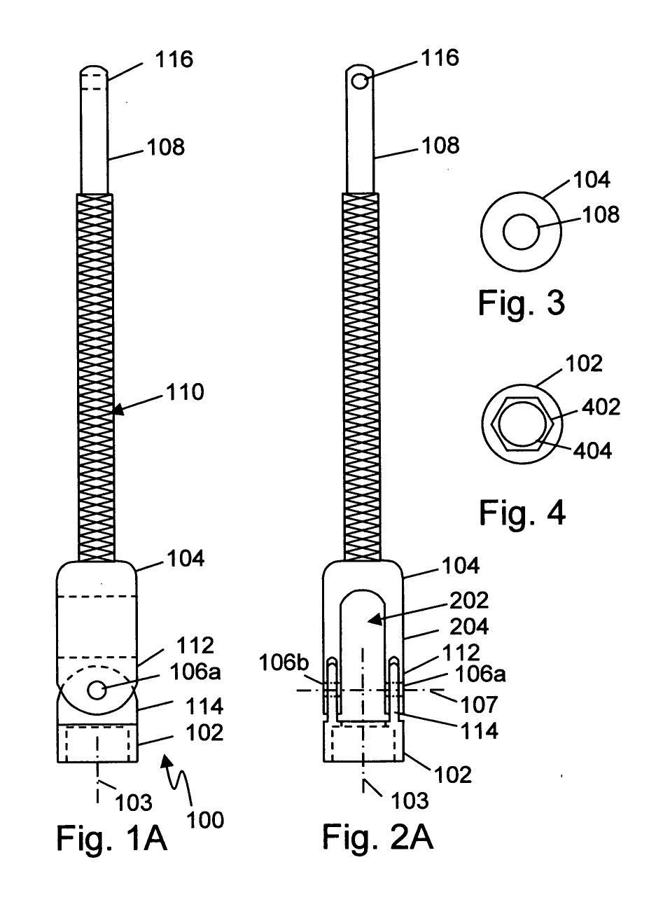

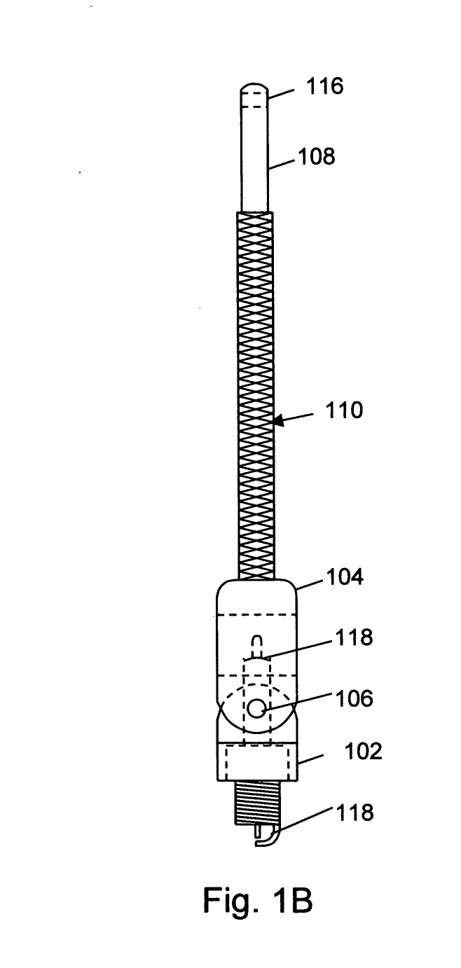

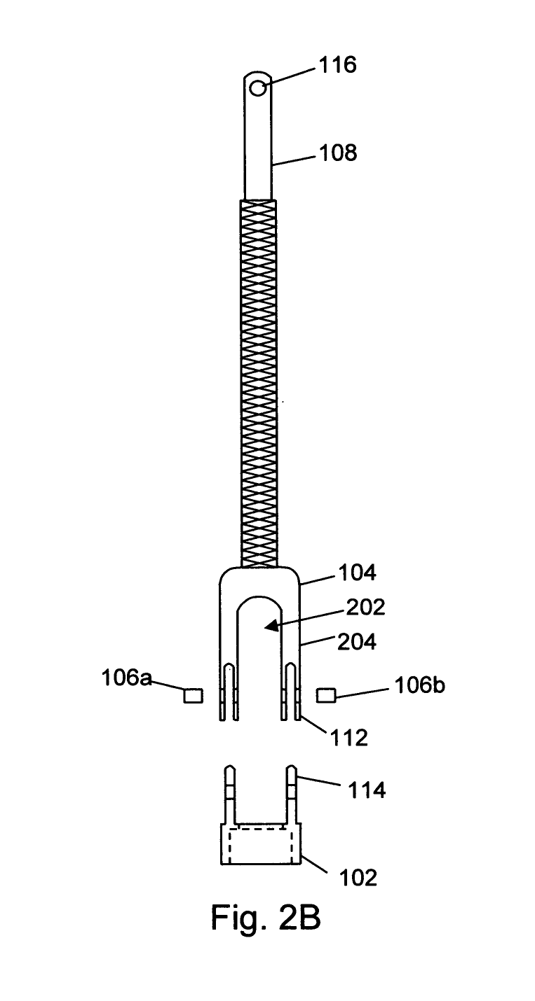

An exemplary embodiment of the present invention will now be described with reference to the figures. FIG. 1A illustrates a side view of an exemplary spark plug wrench in accordance with the present invention. Referring to FIG. 1A, the wrench comprises a socket portion 102 (also called a socket) and a handle portion 104 (also called a handle.) The socket portion 102 is pivotally attached and coupled to the handle portion 104 using pivot hinge including a pair of pivot pins 106a and 106b (106b shown in FIG. 2A). The pivot hinge allows the handle 104 to be pivoted to any angle from a position in line with the socket axis 103 (the position shown in FIG. 1A) to a position perpendicular to the socket axis 103 (not shown). (The socket axis 103 is essentially the rotation axis of a spark plug operated by the socket.) The socket 102 includes a flange 114, which forms part of the hinge. The handle 104 includes a flange 112 as part of the hinge. As shown, the handle 104 includes a first portion having a knurled finish 110 for better gripping. Other gripping finishes or coatings may be used. A second portion 108 of the handle shaft may be squared for use with an open end wrench. A hole 116 is provided in the end of the handle for hanging the wrench for storage.

FIG. 2A is a front view of the wrench. Referring to FIG. 2A, the handle 104 is coupled to the socket 102 at two pivot points using two pivot pins 106a and 106b, one on each side of the socket. The handle 104 includes a U shaped yoke 204 that surrounds a space 202 available to be occupied by the spark plug to allow the handle to rotate up and over the spark plug if necessary. Each arm of the yoke 204 couples to a corresponding flange 114 on the socket. Each arm of the yoke 204 includes a double flange 112, one on each side of the socket flange 114 to balance the forces on the corresponding hinge pin 106a. Alternatively, the socket 102 may include dual flanges on each side and the handle may include a single flange on each side. In a further alternative, the socket and handle may each have a single flange on each side. Other hinge structures may be used as are known in the art.

In the preferred embodiment of FIG. 1A, the hinge axis is above the hex nut drive portion of the socket. Since a typical spark plug is mounted in a well or depression in the engine head, a slight elevation of the handle connecting point aids in accessing the recessed spark plug.

FIG. 2A also shows the hinge, including the coupling pins 106a and 106b, centered on the pivot axis 107. The pivot axis 107 is essentially transverse to the rotation axis 103 and typically may run through the space 202 which may be occupied by the spark plug (alternatively referred to as clearance space 202 for the spark plug). In one embodiment, the pivot axis 107 runs through the center of the spark plug space 202. In another embodiment, the pivot axis 107 is offset from the center of the spark plug space 202 (embodiment not shown.)

FIG. 3 is a top view of the wrench. FIG. 3 illustrates the overall circular shape of the handle yoke portion 104 and socket 102 and the smaller diameter of the knurled 110 handle portion. The handle end of the wrench is designated the top end for reference purposes throughout this disclosure. Conversely, the socket end is designated the bottom end.

FIG. 4 is a bottom view of the wrench. FIG. 4 illustrates the circular outer diameter of the socket 102, the six point hex socket 402 for coupling to the spark plug, and the hole 404 at the top of the socket allowing the socket 102 to fit over the ceramic portion of the spark plug. The ceramic portion of the spark plug may protrude through the socket hole 404 into the space 202 between the arms of the yoke 204. A six point socket drive pattern is shown, but the socket may also be a twelve point drive pattern design. The drive pattern is for coupling to the spark plug for rotating the spark plug around the spark plug rotation axis. The twelve point socket design may allow more radial angle coupling opportunities with the spark plug, which would be an advantage in confined spaces.

FIG. 2B is an exploded view of the wrench of FIG. 2A. FIG. 2B shows the separate physical components: the socket 102, the handle 104, and the two pivot pins 106a and 106b. In one embodiment, the pivot pins 106a, 106b are split steel pins, often called roll pins. In another embodiment, solid pins, or rivets, or shoulder screws may be used. In further embodiments, alternative pivoting structures may be used as are known in the art. The socket 102 may typically be shorter than the exposed portion of the spark plug and may be shorter than the exposed length including the insulator portion and excluding the connection terminal. The exposed portion is the portion exposed when the spark plug is mounted in an engine. The socket, being typically shorter than the spark plug, has a clearance space running through the socket to receive the spark plug. Although the wrench may be designed to accommodate a longer spark plug, the wrench may be used with a shorter spark plug. For illustrative purposes, the longer spark plug is shown in this disclosure.

FIG. 1B illustrates the wrench of FIG. 1A coupled to a spark plug. Referring to FIG. 1B, the wrench of FIG. 1A is shown with the inclusion of a spark plug 118. The spark plug 118 is shown with the hex nut portion coupled to the socket 102 and the ceramic portion including connection electrode protruding into the space 204 between the yoke arms. It can be seen that the pivot axis 107 (center of pin 106a) is below the top of the spark plug 118. Typically, the pivot axis 107 may be described as intersecting the insulator portion of the spark plug.

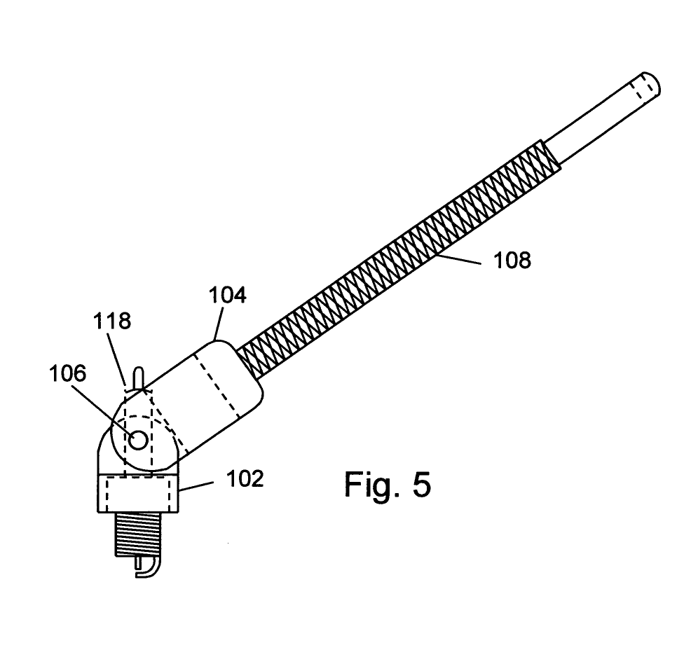

FIG. 5 illustrates the wrench and spark plug of FIG. 1B with the handle pivoted to an angle of about 45 degrees. The configuration of FIG. 5 represents a typical operation configuration for the wrench. A 90 degree angle (horizontal in FIG. 5) may be preferred for ideal application of torque to the spark plug, but may not be available due to interference with other engine components. Thus, the pivot hinge and yoke 204 with space 202 for the spark plug 118 allow the handle 104 to assume any angle from 90 degrees to 0 degrees, with respect to the spark plug 118 and socket 102 to best accommodate a wide range of engine configurations.

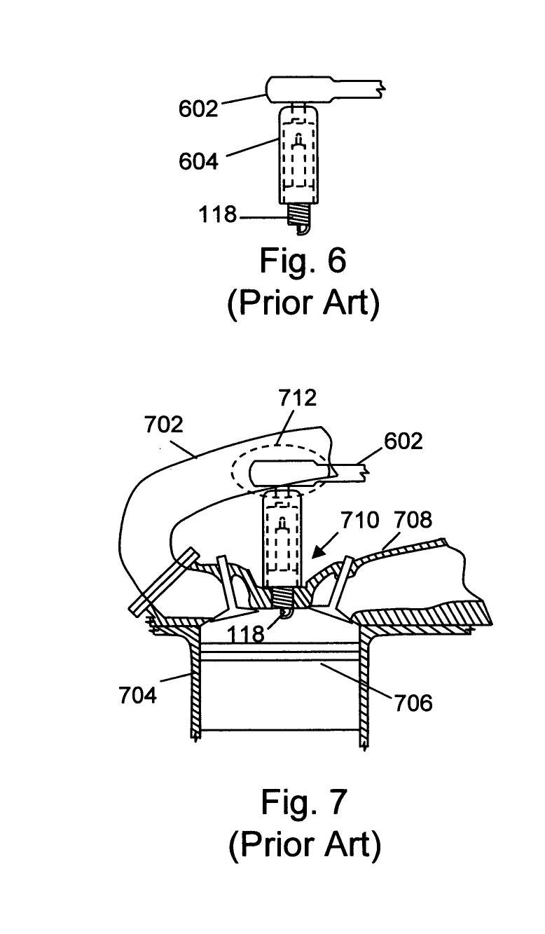

The advantages of the present invention may be better understood by comparison with the prior art. FIG. 6 (prior art) illustrates a conventional spark plug wrench. A typical prior art spark plug wrench comprises a specially designed socket 604 made to enclose the exposed portion of the spark plug 118. The prior art socket 604 includes a hex coupling at the bottom and a square wrench coupling at the top. The square wrench coupling couples to a standard ratchet wrench 602. One problem with the conventional spark plug wrench is that the length required for the prior art socket 604 and wrench 602 may not be available in a given automotive situation due to interference with engine components.

FIG. 7 (prior art) illustrates a typical engine configuration showing the potential interference that prevents the use of the conventional spark plug wrench. Referring to FIG. 7, a cylinder 704 is shown with associated components: the spark plug 118, a piston 706, a head 708, an exhaust header 702, and the conventional spark plug wrench 602 of FIG. 6. Note that the exhaust header 702 and the conventional spark plug wrench 602 must occupy the same physical space 712 in order to operate, thus preventing the use of the conventional spark plug wrench 602. In this situation, an open end wrench would often be used diagonally, partially coupling to the spark plug, risking damage to the spark plug. Alternatively, the header 702 may be removed for direct access to the spark plug, increasing the time and cost of repair.

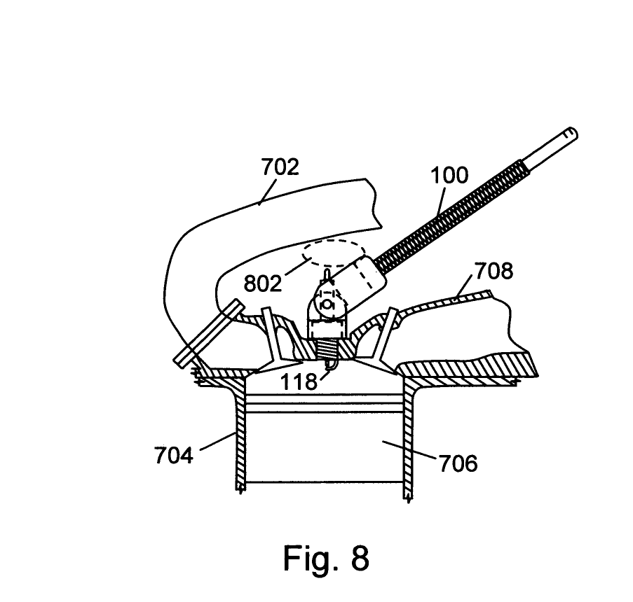

FIG. 8 illustrates the engine configuration of FIG. 7 with the operation of the wrench of FIG. 1A in accordance with the present invention. Referring to FIG. 8, the wrench 100 fits easily into the space available, allowing clearance 802 above the spark plug 118 and below the header 702. The wrench 100 couples squarely to the spark plug 118, engaging all of the flats of the hex nut. The handle 104 is adjustable to a pivot angle where space is available to operate the wrench 100.

An insallation procedure for the spark plug 118 in accordance with the present invention will now be described with reference to FIG. 8. The spark plug 118 may be initially inserted and tightened by hand. The socket portion 102 of the wrench 100 may then be slipped over the top of the spark plug 118, rotated at the pivot axis 107, and lowered to engage the hex nut of the spark plug 118. The spark plug 118 may then be turned by applying lateral force to the grip part of the handle 108 to further tighten the spark plug 118. The spark plug wrench 100 may then be removed by lifting the socket portion 102 up and rotating the socket portion 102 at the pivot axis 107 and then slipping the wrench 100 over the top of the spark plug 118 to remove the wrench 100. A procedure for removing the spark plug may follow the reverse of the installation procedure.

Fabrication of the wrench 100 may be done by conventional tool making techniques. The handle and socket may be made by forging followed by machining or grinding of critical surfaces. Other techniques may be used as are known in the art of tool making. The spark plug wrench may be preferably made of tool steel and finished with a hard chrome plating of tool quality, however, other finishes may be applied.

The wrench may be adapted to any size spark plug. Typical spark plug hex nut sizes include 9/16 inch (0.5625 inch, 14.8 mm), ⅝ inch (0.625 in, 15.8 mm), 13/16 inch (0.8125 in, 20.64 mm), and ¾ inch (0.750 in, 19.05 mm). Typical metric hex nut sizes include 18 mm and 21 mm. In one embodiment, the same handle may be used with different sockets for different size spark plugs. In one embodiment adapted for a ⅝ inch spark plug, the narrow part of the handle may be 6 inches (15.2 cm) in length with 1.5 inches (3.8 cm) square cross section (0.3125 inch 7.9 mm square) with the remaining 4.5 inches (11.4 cm) knurled for better grip (0.375 inch diameter (9.5 mm)). The yoke may be 2 inches (5.08 mm) in length and the socket may be 0.5 inch (12.7 mm) in length, excluding hinge flanges, and 0.875 inch (22.2 mm) outside diameter. The socket flange may be 0.7 inch (18 mm) in length, extending the socket to 1.2 inches (30.5 mm) overall. Typically, the socket may be less than 5 cm in overall length. The pivot axis may be 0.90 inch (23 mm) above the bottom of the socket. Typically, the pivot axis may be greater than one centimeter from the bottom of the socket.

A typical spark plug may have an exposed length of from 1.0 to 2.25 inches (2.54 to 5.7 cm.) The exposed length is the length from the seating surface to the end of the connection electrode and includes the hex nut and ceramic portion, i.e., the portion that is exposed when the spark plug is installed in an engine.

In an alternative embodiment, the handle may be curved, or the grip portion of the handle (the knurled portion) may be offset from center or both. In a further alternative, the pivot axis may be offset from the center of the spark plug. With a slight increase in size of the socket, the pivot axis may be off center sufficiently that the pivot axis does not pass through the space for the spark plug.

In a further alternative, a ratchet mechanism may be provided between the pivot and the socket. The ratchet mechanism may be provided with a clearance hole allowing the ceramic portion of the spark plug to protrude through the center of the ratchet.

In a further alternative, a rubber pad in the form of a tube or ring may be provided to hold a spark plug and/or provide padding for the ceramic portion of the spark plug. Alternatively, the spark plug may be retained by a friction spring.

### CONCLUSION

Thus, herein described is an improved spark plug wrench that can be used in the confined spaces found in today's advanced engines.

While particular embodiments of the invention have been described, it will be understood, however, that the invention is not limited thereto, since modifications may be made by those skilled in the art, particularly in light of the foregoing teachings. It is, therefore contemplated by the appended claims to cover any such modifications that incorporate those features or those improvements which embody the spirit and scope of the present invention.

1.-8. (canceled)

9. A wrench for a spark plug, said wrench comprising:
a socket having a single rotation drive pattern, said rotation drive pattern disposed on a first end of said socket for coupling to said spark plug,
said rotation drive pattern having a rotation axis,
said socket having an overall length of less than five centimeters,
said socket having a first clearance space through said socket for receiving said spark plug; and
a handle pivotally attached to said socket at a second end of said socket by a pivotal attachment having a pivot axis transverse to said rotation axis and passing through said first clearance space,
said handle having a second clearance space for avoiding said spark plug,
said handle coupling to said socket at two locations, each of said two locations on opposite sides of said socket.

10.-14. (canceled)

15. The wrench of claim 9, wherein the drive pattern is a six point pattern or a twelve point pattern.

16. The wrench of claim 9, wherein the pivot axis is greater than or equal to one centimeter from the bottom end of the socket.

17. A wrench for a spark plug, said wrench comprising:
a socket component having a drive pattern for engaging said spark plug on a drive end of said socket component,
said socket component having a handle attachment portion occupying the end opposite said drive end of said socket component,
said socket component having a clearance space through said socket component for receiving an insulator portion of said spark plug,
said socket component having an overall length less than five centimeters; and
a handle component, said handle component having a U shaped yoke on one end; said yoke pivotally attached to said attachment portion of said socket component by a pivot hinge; wherein the axis of said pivot hinge passes through said clearance space through said socket component.

18. The wrench of claim 17, wherein the drive pattern is a six point pattern or a twelve point pattern.

19. The wrench of claim 17, wherein the pivot axis is greater than or equal to one centimeter from the drive end of the socket component.

20. (canceled)

21. The wrench of claim 17, wherein said attachment portion of said socket component comprises a pair of flanges, each of said flanges disposed on opposite sides of said socket component.

22. The wrench of claim 21, wherein each flange of said pair of flanges has a curved edge.

23. The wrench of claim 22, wherein said curved edge is a circular arc.

24. The wrench of claim 9, wherein said attachment portion of said socket component comprises a pair of flanges, each of said flanges disposed on opposite sides of said socket component.

25. The wrench of claim 24, wherein each flange of said pair of flanges has a curved edge.

26. The wrench of claim 25, wherein said curved edge is a circular arc.

27. The wrench of claim 17, further including a spark plug coupled to said wrench wherein said axis of said pivot hinge passes through an insulator portion of said spark plug.

28. A method for installing a spark plug comprising:
providing a spark plug wrench constructed in accordance with claim 17;
inserting and tightening said spark plug by hand;
slipping said socket component over said spark plug;
engaging said socket component on a hex nut portion of said spark plug;
rotating said handle component in accordance with the pivot axis to position the handle component for applying torque to the spark plug;
rotating the handle component in accordance with a spark plug axis to tighten the spark plug.
